(19) United States
(12) Patent Application Publication
(10) Pub. No.: US 2004/0076373 A1
(43) Pub. Date: Apr. 22, 2004

(54) Optical pulse regenerating transmission lines

(76) Inventors: Keith James Blow, Birmingham (GB); Sergei Konstantinovich Turitsyn, Birmingham (GB); Sonia Annarita Boscolo, Birmingham (GB)

Correspondence Address: SUGHRUE MION, PLLC, 401 Castro Street, Ste 220, Mountain View, CA, 94041-2007, US

(21) Appl. No.: 10/250,890

(22) PCT Filed: Jan. 10, 2002
(86) PCT No.: PCT/GB02/00082

(30) Foreign Application Priority Data
Jan. 10, 2001 (GB) 0100603.0

(51) Int. Cl. G02B 6/26

(52) U.S. Cl. 385/27; 385/122

(57) ABSTRACT

In the present invention an optical pulse regenerating transmission line element includes a section of disbursement managed optical fibre transmission line in optical communication with an unbalanced optical interferometer. The transmission line element may be particularly suitable for use with RZ optical pulses, and in particular optical solitons. The dispersion managed optical fibre transmission line includes a first section of optical fibre having a negative dispersion coefficient, connected to a second section of optical fibre having a positive dispersion coefficient. This first section of fibre may be dispersion compensating fibre and the second section of fibre may be standard monomode fibre. It is preferred that the first and second sections of optical fibre are arranged to form a section of dispersion managed optical fibre transmission line having a symmetric dispersion map.

### FIELD OF THE INVENTION

This invention relates to an optical pulse regenerating transmission line element which is particularly, but not exclusively, for use in long distance, high capacity optical fibre transmission lines employing return-to-zero (RZ) optical pulses. The invention also relates to components for an optical pulse regenerating transmission line, and to an optical pulse regenerating transmission line.

### BACKGROUND OF THE INVENTION

At high bit rates optical communication systems suffer degradation of their transmission capacity. This is mainly due to the detrimental effects on the optical pulses of chromatic dispersion, fibre non-linearity and noise from optical amplifiers in the system.

In the transmission of soliton pulses, positive use is made of the fibre non-linearity by achieving a balance with the pulse broadening due to dispersion in the region of the anomalous chromatic dispersion. Conventional soliton transmission lines comprise optical fibre which has a constant, or slightly varying, dispersion coefficient. However, the distance overwhich soliton pulses may be transmitted along such a transmission line is limited by two contradicting requirements: the dispersion must be low in order to minimise Gordon-Haus timing jitter, which is driven by optical amplifier noise; and the dispersion must be high in order to suppress four-wave mixing in wavelength division multiplexed transmission systems.

This contradiction is resolved by using a technique known as dispersion management in which the optical fibre transmission line has high local dispersion and low path-average dispersion. This is achieved by using alternating lengths of large positive dispersion and large negative dispersion fibres. Dispersion management is a powerful technique which enhances the quality of the data transmission, and increases both the data transmission rate for a single optical channel and the aggregate capacity of a transmission system.

Dispersion management is increasingly being used for the transmission of data at high bit rates in standard monomode fibre (SMF). The problem of increasing the data rate and the error free propagation distance in SMF is becoming very important because of its application to the upgrade of existing terrestrial links. In high bit rate dispersion managed (DM) communication lines employing RZ pulses, intersymbol interference, in which pulses broaden and overlap with their neighbours, is a major limitation. In DM communication lines which include SMF, the intersymbol interference is produced by the generation of dispersive waves shed by pulses propagating on SMF. The use of optical filters to clean up the pulses can lead to the undesirable generation of dispersive radiation at the carrier frequency.

The suppression of dispersive radiation, whilst allowing the pulses to propagate, is a critical issue in achieving unlimited propagation distances. A known method is to use in-line regeneration based on intensity and phase modulation. In practice this active regeneration method involves a technique known as clock recovery, which is difficult and expensive to implement, plus some form of high speed optical modulation.

### SUMMARY OF THE INVENTION

According to a first aspect of the present invention there is provided an optical pulse regenerating transmission line element comprising a section of dispersion managed optical fibre transmission line in optical communication with an unbalanced optical interferometer.

The transmission line element may be particularly suitable for use with return-to-zero optical pulses, and in particular optical solitons.

The dispersion managed optical fibre transmission line preferably comprises a first section of optical fibre, having a negative dispersion coefficient, connected to a second section of optical fibre, having a positive dispersion coefficient. The first section of fibre may be dispersion compensating fibre. The second section of fibre may be standard monomode fibre.

The first and second sections of optical fibre are preferably arranged to form a section.-of dispersion managed optical fibre transmission line having a symmetric dispersion map. The first and second sections of optical fibre may alternatively be arranged to form a section of dispersion managed optical fibre transmission line having a pre-compensating dispersion map, or a post compensating dispersion map.

The unbalanced optical interferometer is preferably a Sagnac interferometer. The Sagnac interferometer is desirably a fibre optic Sagnac interferometer, and is most preferably a non-linear loop mirror.

The non-linear loop mirror preferably comprises a 2×2 optical coupler, a first port on one side of the couplerforming the input to the non-linear optical loop mirror, the second port on the one side forming the output to the nonlinear optical loop mirror, and the ports on the other side of the coupler being connected together by a section of optical waveguide, to form a waveguide loop.

The optical coupler is desirably a fibre optic coupler, or may alternatively be a semiconductor waveguide device. The optical waveguide preferably comprises a section of optical fibre. The optical waveguide may alternatively or additionally comprise a section of semiconductor waveguide.

The coupler is preferably a balanced coupler having a power-splitting ratio of 50:50. The non-linear loop mirror is desirably an amplifying non-linear loop mirror, comprising an optical amplifier asymmetrically located within the fibre loop. The loop optical amplifier is preferably located within the loop close to the coupler. The loop optical amplifier is desirably an erbium doped fibre amplifier. The ports on the other side of the coupler are desirably connected together by a section of dispersion shifted optical fibre. The non-linear loop mirror is preferably highly non-linear.

The non-linear loop mirror may alternatively be an absorption non-linear loop mirror, comprising an absorption element asymmetrically located within the fibre loop. The non-linear loop mirror may further alternatively be a dispersion imbalanced non-linear loop mirror or an imbalanced coupler nonlinear loop mirror.

Desirably, the non-linear loop mirror operates within a region of its switching curve in which the output power of the non-linear loop mirror is substantially stable against small changes in the input power to the non-linear loop mirror. The non-linear loop mirror preferably operates in the region just after the first peak of its switching curve.

Desirably, the optical power of a pulse when output from the optical pulse regenerating transmission line element is substantially the same as the optical power of the pulse when input into the optical pulse regenerating transmission line element.

The optical pulse regenerating transmission line element preferably further comprises an optical power loss element provided at the output of the non-linear loop mirror. The loss element may be an absorption element, or may 1.5 be an imperfection in the optical waveguide, such as an imperfect splice between two sections of optical fibre.

The optical pulse regenerating transmission line element˜may further comprise a second optical amplifier provided between the dispersion managed optical fibre transmission line and the non-linear loop mirror. The second optical amplifier is preferably an erbium doped fibre amplifier.

The loss element and the second optical amplifier provide for control of the peak power of the optical pulse. This is advantageous because the dispersion managed transmission line will generally have a different optimum pulse power level than the non-linear loop mirror. In general, the optimum pulse power level of the loop mirror will be higher than the optimum pulse power level of the dispersion managed transmission line.

The length of the loop and the gain of the loop optical amplifier and/or the second optical amplifier are preferably determined in terms of the input power to the non-linear loop mirror. The input power to the non-linear loop mirror is desirably the peak power of an optical pulse to be transmitted through the non-linear loop mirror. The pulse peak power is preferably selected to produce good behaviour of the pulse in the dispersion managed optical fibre transmission line. The pulse peak power is desirably greater than 3 mW, and is most preferably in the range 3.5 mW to 5 mW.

The optical pulse regenerating transmission line element may alternatively or additionally comprise a third optical amplifier provided at a s location along the dispersion managed optical fibre transmission line. The said location is desirably on the section of negative dispersion fibre, most preferably substantially at the mid point of the section of negative dispersion fibre. The third optical amplifier is preferably an erbium doped fibre amplifier.

The optical pulse regenerating transmission line element desirably 10 further comprises an optical filter after each of the second and third optical amplifiers. Each optical filter desirably has a substantially Gaussian shaped transmission spectral profile. The bandwidth of the spectral profile is preferably generally 1.5 times the spectral bandwidth of the optical pulse.

According to a further aspect of the present invention there is provided 15 optical pulse regenerating transmission line components for incorporation into an existing terrestrial communication line which comprises a section of a first optical fibre having a dispersion coefficient of a first sense, the components comprising:

a section of a second optical fibre, having a dispersion coefficient of the opposite sense, connectable in optical communication to a section of the first optical fibre to form therewith a dispersion managed transmission line,

and an unbalanced optical interferometer connectable in optical communication to the dispersion managed transmission line.

The second optical fibre preferably has a negative dispersion coefficient, and is most preferably dispersion compensating fibre.

The negative dispersion fibre and the standard monomode fibre may be arranged to form a dispersion managed optical fibre transmission line having a pre-compensating dispersion map. Alternatively, the negative dispersion fibre and the standard monomode fibre may be arranged to form a dispersion managed-optical fibre transmission line having a post-compensating dispersion map.

Preferably, two sections of negative dispersion fibr are provided. The sections of negative dispersion fibre and the standard monomode fibre are desirably arranged to form a dispersion managed optical fibre transmission line having a symmetric dispersion map.

The first and second sections of optical fibre are preferably arranged to form a section of dispersion managed optical fibre transmission line having a symmetric dispersion map. The first and second sections of optical fibre may alternatively be arranged to form a section of dispersion managed optical fibre transmission line having a pre-compensating dispersion map, or a post compensating dispersion map.

The unbalanced optical interferometer is preferably a Sagnac interferometer. The Sagnac interferometer is desirably a fibre optic Sagnac interferometer, and is most preferably a non-linear loop mirror.

The non-linear loop mirror preferably comprises a 2×2 optical coupler, a first port on one side of the coupler forming the input to the non-linear optical loop mirror, the second port on the one side forming the output to the nonlinear optical loop mirror, and the ports on the other side of the coupler being connected together by a section of optical waveguide, to form a waveguide loop.

The optical coupler is desirably a fibre optic coupler, or may alternatively be a semiconductor waveguide device. The optical waveguide preferably comprises a section of optical fibre. The optical waveguide may alternatively or additionally comprise a section of semiconductor waveguide.

The coupler is preferably a balanced coupler having a power-splitting ratio of 50:50. The non-linear loop mirror is desirably an amplifying non-linear loop mirror, comprising an optical amplifier asymmetrically located within the fibre loop. The loop optical amplifier is preferably located within the loop close to the coupler. The loop optical amplifier is desirably an erbium doped fibre amplifier. The ports on the other side of the coupler are desirably connected together by a section of dispersion shifted optical fibre. The non-linear loop mirror is preferably highly non-linear.

The non-linear loop mirror may alternatively be an absorption non-linear loop mirror, comprising an absorption element asymmetrically located within the fibre loop. The non-linear loop mirror may further alternatively be a dispersion imbalanced -non-linear loop mirror or an imbalanced coupler nonlinear loop mirror.

Desirably, the non-linear loop mirror operates within a region of its switching curve in which the output power of the non-linear loop mirror is substantially stable against small changes in the input power to the non-linear loop mirror. The non-linear loop mirror preferably operates in the region just after the first peak of its switching curve.

Desirably, the optical power of a pulse when output from the optical pulse regenerating transmission line element is substantially the same as the optical power of the pulse when input into the optical pulse regenerating transmission line element.

The optical pulse regenerating transmission line components preferably further comprise an optical power loss element provided at the output of the non-linear loop mirror. The loss element may be an absorption element, or may be an imperfection in the optical waveguide, such as an imperfect splice between two sections of optical fibre.

The optical pulse regenerating transmission line components may further comprise a second optical amplifier provided between the dispersion managed optical fibre transmission line and the non-linear loop mirror. The second optical amplifier is preferably an erbium doped fibre amplifier.

The length of the loop and the gain of the loop optical amplifier and/or the second optical amplifier are preferably determined in terms of the input power to the non-linear loop mirror. The input power to the non-linear loop mirror is desirably the peak power of an optical pulse to be transmitted through the non-linear loop mirror. The pulse peak power is preferably selected to produce good behaviour of the pulse in the dispersion managed optical fibre transmission line. The pulse peak power is desirably greater than 3 mW, and is most preferably in the range 3.5 mW to 5 mW.

The optical pulse regenerating transmission line components may alternatively or additionally comprise a third optical amplifier provided at a location along the dispersion managed optical fibre transmission line. The said location is desirably on the section of negative dispersion fibre, most preferably substantially at the mid point of the section of negative dispersion fibre. The third optical amplifier is preferably an erbium doped fibre amplifier.

The optical pulse regenerating transmission line components desirably further comprise an optical filter after each of the second and third optical amplifiers. Each optical filter desirably has a substantially Gaussian shaped transmission spectral profile. The bandwidth of the spectral profile is preferably generally 1.5 times the spectral bandwidth of the optical pulse.

The components may be particularly suitable for use with a terrestrial communication line comprising at least one section of standard monomode fibre, optical pulse regenerating transmission line components being incorporated into the communication line in association with the or each section of standard monomode fibre. The components may also be particularly suitable for use with a communication line for transmitting return-to-zero optical pulses, and in particular optical solitons.

According to a further aspect of the present invention there is provided an optical pulse regenerating transmission line comprising a plurality of optical pulse regenerating transmission line elements, according to any of paragraphs seven to eighteen above, connected in optical communication in series.

Desirably, the optical power of a pulse delivered from a first optical pulse regenerating transmission line element to the dispersion managed transmission line of the subsequent optical pulse regenerating transmission line element is substantially the same as the optical power of the pulse when output from the dispersion managed transmission line of the first optical pulse regenerating transmission line element.

The dispersion managed optical fibre transmission line preferably comprises a plurality of periods of a dispersion map, most preferably of a symmetric dispersion map. A third optical amplifier is desirably provided after each period of the dispersion map. A third optical amplifier may alternatively or additionally be provided at a location along the dispersion managed optical fibre transmission line. The said location is desirably on the section of negative dispersion fibre, most preferably substantially at the mid point of the section of negative dispersion fibre. An optical filter is preferably provided after each third optical amplifier.

### BRIEF DESCRIPTION OF THE DRAWINGS

Examples of the present invention will now be described in detail with reference to the accompanying drawings, in which:

FIG. 1 is a schematic representation of an optical pulse regenerating transmission line element according to an aspect of the present invention;

FIG. 2 is an enlarged schematic representation of an optical fibre non-linear loop mirror suitable for use in the transmission line element of FIG. 1;

FIG. 3 is a graph showing the CW switching curve of the non-linear loop mirror of FIG. 2;

FIG. 4 is a schematic representation of optical pulse regenerating transmission line components according to a further aspect of the present invention for incorporation into an existing standard monomode fibre communication line;

FIG. 5 is a schematic representation of an optical pulse regenerating transmission line according to a further aspect of the present invention;

FIG. 6 is a schematic representation of an alternative optical pulse regenerating transmission line according to a further aspect of the present invention;

FIG. 7 is a graph illustrating the propagation of an optical pulse in a conventional dispersion managed optical communication line;

FIG. 8 is a graph illustrating the propagation of an optical pulse in an optical pulse regenerating transmission line according to the present invention;

FIG. 9 is a graph illustrating the variation of the Q-value as a function of propagation distance of a pulse along an optical pulse regenerating transmission line according to an aspect of the present invention; and,

FIG. 10 is a graph illustrating the variation of the mean Q-value as a function of the optical pulse peak power at the non-linear loop mirror input in an optical pulse regenerating transmission line according to an aspect of the present invention.

### DETAILED DESCRIPTION

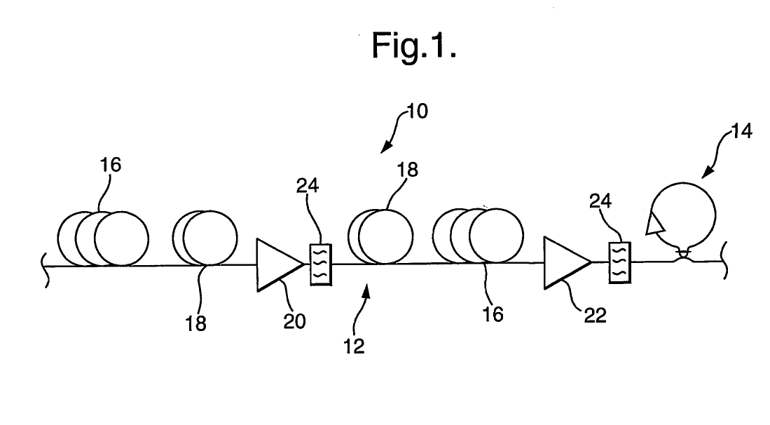

Referring to FIGS. 1 to 3, a first aspect of the present invention provides an optical pulse regenerating transmission line element 10. The transmission line element 10 comprises a section of dispersion managed (DM) optical fibre transmission line 12 in optical communication with an unbalanced optical interferometer, which in this example is a non-linear loop mirror (NOLM) 14.

In this example, the DM transmission line comprises two sections of standard monomode fibre (SMF) 16 and two sections of dispersion compensating fibre (DCF) 18. The standard monomode fibre has a dispersion coefficient of 15 ps/(nm km), an effective area of 70 μm², and an attenuation of 0.22 dB/km. The length of each section of SMF is 32.3 km. The DCF has a dispersion coefficient of −71.2 ps/(nm km), an effective area of 30 μm², and an attenuation of 0.65 dB/km. Each section of DCF is 6.8 km in length. The sections of SMF and DCF are arranged to give the DM transmission line a symmetric dispersion map.

A first optical amplifier 20 is provided between the sections of DCF 18 and a second optical amplifier 22 is provided after the section of SMF 16 which is last in the direction of travel of the optical signal i.e. from left to right across the page of FIG. 1. In this example, both of the optical amplifiers 20, 22 are erbium doped fibre amplifiers (EDFA). An optical filter 24 follows each of the optical amplifiers 20, 22. Each optical filter is a Gaussian-filter, that is to say the optical filter has a Gaussian shaped transmission spectral profile, having a bandwidth of 0.3 THz.

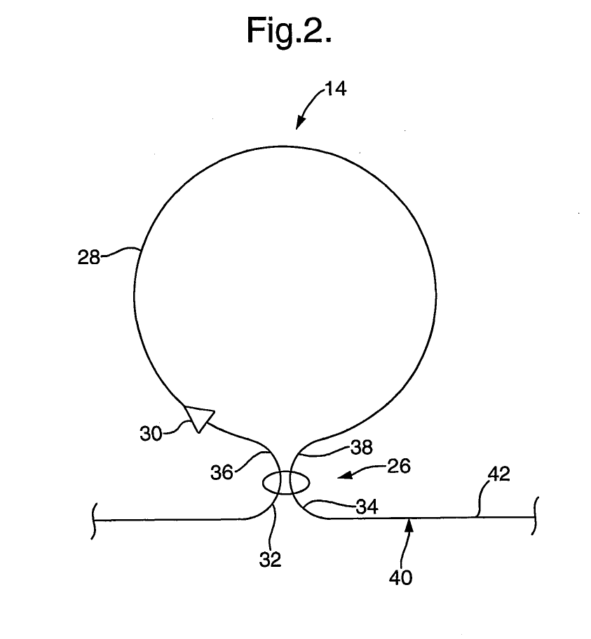

Referring in particular to FIG. 2, the non-linear loop mirror 14 (NOLM) in this example is an absorption non-linear loop mirror which comprises a fibre optic coupler 26, a loop of optical fibre 28, and an optical amplifier 30. The fibre optic coupler 26 is a 2×2 coupler having a power splitting ratio of 50:50. The first port 32 of the coupler 26 is, as can be seen in FIG. 1, connected to the DM transmission line 12, following the last optical filter 24. The first port 32 of the coupler 26 therefore forms the input to the NOLM 14. The second port 34 of the coupler 26 forms the output of the NOLM 14. The third port 36 and the fourth port 38 of the coupler 26 are connected together via the fibre loop 28. The NOLM 14 is followed by a loss element, which in this example is an imperfect splice 40 between the output port 34 and the subsequent section of fibre 42.

The NOLM fibre loop 28 is a loop of dispersion shifted fibre (DSF). The DSF has a dispersion coefficient of 0 ps/(nm km), an effective area of 25 μm², and an attenuation of 0.3 dB/km. The length of the fibre loop 28 is 45.3 km.

The loop amplifier 30 is an EDFA having a noise figure of 4.5 dB and a power gain of 14.8 dB. The loop amplifier 30 is asymmetrically located within the fibre loop 28, close to the coupler 26. The asymmetric location of the loop amplifier 30 is required in order to make the NOLM 14 .unbalanced.

Unbalancing of the NOLM 14 is required in order to ensure that all of the optical pulses entering the NOLM 14, through the input 32, are transmitted by the NOLM 14, through the output 34.

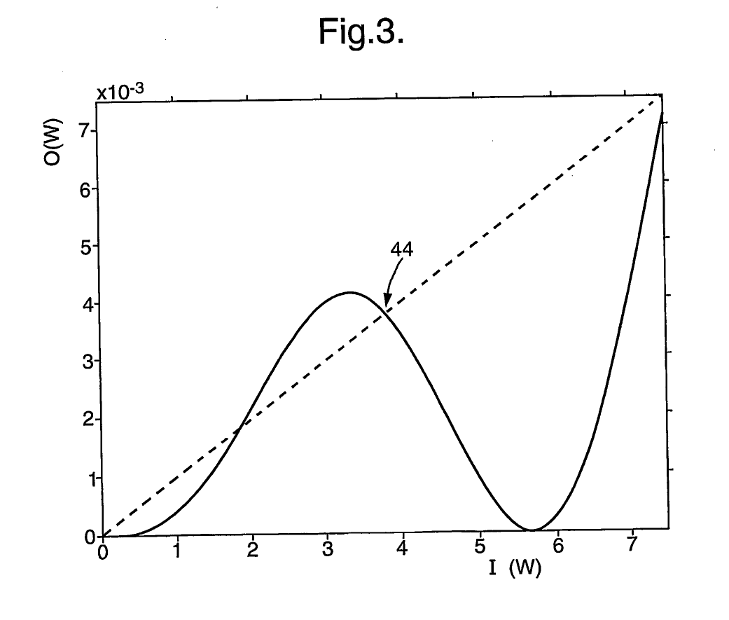

FIG. 3 shows the relationship between the input power I(W), in Watts, of the NOLM 14 to its output power 0(W). The NOLM 14 is required to operate in the region 44 just after the first peak of its switching curve. By operating the NOLM 14 in the region 44 of the switching curve, any change in the input power to the NOLM 14 results in a smaller negative change in the output power from the NOLM 14. The output power from the NOLM 14 is therefore substantially stable against small changes in the input power.

The length of the NOLM loop 28 and the gain of the loop amplifier 30 are determined in terms of the peak power of the pulses input into the NOLM 14. The pulse peak power is then selected to produce good behaviour in the DM transmission line 12.

Each of the DM transmission line 12 and the NOLM 14 have a preferred optical power level at which optimum performance is achieved. However, the preferred power levels are not generally the same. The preferred power level of the NOLM 14 in this example is higher than the preferred power level of the DM transmission line 12. In addition, the peak power of an optical pulse leaving a transmission line element 10 is required to be essentially equal to-the peak power of the pulse on entering the transmission line element 10.

A pulse travelling along the optical pulse regenerating transmission line element 10 therefore has a first peak optical power level during transmission along the DM transmission line 12 and a second, higher, peak optical power level during transmission through the NOLM 14. The pulse peak optical power level is amplified from the first power level to the second power level by the second EDFA 22 before the pulse enters the NOLM 14, and by the loop amplifier 30. Following transmission through the NOLM 14, the pulse peak optical power level is reduced from the second power level to the first, lower, power level by the lossy-splice 40. The pulse is then at the appropriate power level to be launched into the DM transmission line 12 of a subsequent optical pulse regenerating transmission line element 10.

A pulse being transmitted along the optical pulse regenerating transmission line element 10 will initially travel through a first section of SMF 16, where the pulse will experience a positive dispersion coefficient, causing the pulse to broaden. The pulse then travels along a first section of DCF 18 in which the pulse experiences a large negative dispersion coefficient, causing the pulse to narrow. On leaving the DCF 18 the pulse is amplified in the EDFA 20 in order to compensate for power loss experienced as a result of transmission through the SMF 16 and DCF 18 fibre sections. Following amplification by the EDFA 20, the pulse is transmitted through an optical filter 24, in order to remove noise added to the pulse by the optical amplifier 20. The pulse is then transmitted through a second section of DCF 18 and a second section of SMF 16, followed by the second EDFA 22 and a second optical filter 24. The DM transmission line 12 has a path average dispersion of 0.009 ps/(nm km). Therefore, following transmission down the DM transmission line 12, the width of each pulse will have increased slightly.

In this example the optical pulse is a soliton, but it will be appreciated that other return-to-zero pulse types may be utilised. During propagation of soliton pulses along SMF, dispersive waves are generally shed by the pulses. These dispersive waves can result in intersymbol interference, where the pulses are caused to broaden and overlap. Optical filters that can help to clean up the pulses create undesirable generation of dispersive radiation at the carrier frequency. In addition, during the propagation of optical signals, such as optical pulses, along optical fibre, amplified spontaneous emission noise can also be generated. The amount of noise on the pulses will therefore also have increased as a result of propagating along the DM transmission line 12.

The NOLM 14 is an unbalanced optical fibre Sagnac interferometer. The transmission characteristics of the NOLM 14 are such that the NOLM 14 essentially behaves as a saturable absorber, i.e. it does not transmit low power optical signals. The NOLM 14 therefore removes any low power noise between pulses. That is to say, the NOLM 14 suppresses the build-up of noise generated by the optical amplifiers 20, 22, the optical filters 24, dispersive radiation waves, and amplified spontaneous emission noise. Transmission through the NOLM 14 therefore causes the pulse width to be reduced and the amount of noise on the pulse to be reduced. In addition, the NOLM 14 acts to stabilise the peak amplitude of the pulses.

In the optical pulse regenerating transmission line element 10, a balance is achieved between the effects of pulse broadening caused by the DM transmission line 12 and the pulse narrowing caused by the NOLM 14. This results in an increase in the potential pulse propagation distance as compared with a conventional DM transmission line.

In addition, the saturable absorber transmission characteristics of the NOLM 14 enables narrower bandwidth optical filters to be used than is possible in conventional DM communication lines, without encountering pulse instability. This helps to increase the suppression of Gordon-Haus timing jitter and reduces the effect of pulse-to-pulse interactions.

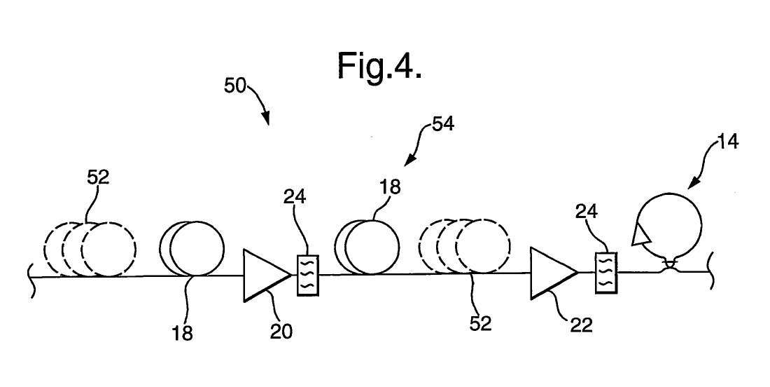

A second embodiment of the invention, shown in FIG. 4, provides optical pulse regenerating transmission line components 50 for incorporation into an existing terrestrial standard monomode fibre communication line. The same reference numerals are retained for corresponding features.

The optical pulse regenerating transmission line components 50 comprise a section of optical fibre having a negative dispersion coefficient, in this example dispersion compensating fibre (DCF) 18, connected in optical communication to a section of standard monomode fibre (SMF) 52. The components 50 also comprise an NOLM 14, EDFAs 20, 22 and optical filters 24, as described above.

In this example, the standard monomode fibre 52 forms part of an existing terrestrial communication line. The sections of DCF 18 are connected between two existing sections of SMF 52, so that the DCF 18 sections and the SMF 52 sections together form a DM transmission line 54, which has a symmetric dispersion map.

Once the components 50, namely the DCF 18, EDFAs 20, 22, filters 24 and NOLM 14, are incorporated into the SMF communication line, as shown in FIG. 4, an optical pulse regenerating transmission line element is formed, which is essentially the same as the transmission line element 10 of the first embodiment, shown in FIG. 1. Existing terrestrial communication lines can therefore be readily upgraded into incorporate optical pulse regenerating transmission line elements comprising a DM transmission line 54 and a NOLM 14.

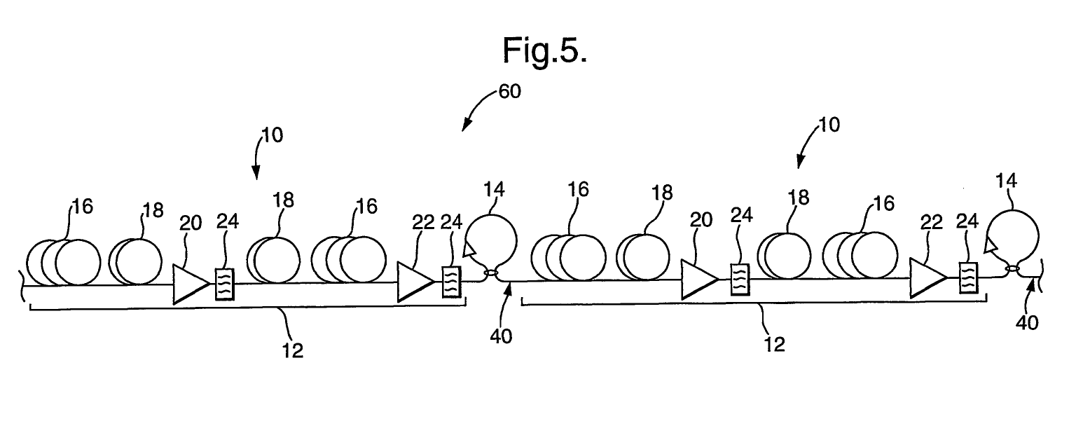

A third embodiment of the present invention, shown in FIG. 5, provides an optical pulse regenerating transmission line 60. The same reference numerals are retained for corresponding features. The transmission line 60 comprises a plurality of optical pulse regenerating transmission line elements 10, according to the first embodiment, connected in optical communication in series. That is, the transmission line 60 comprises a plurality of DM transmission lines 12, each DM transmission line 12 being followed by a NOLM 14.

Each DM transmission line 12 comprises two sections of SMF 16 and two sections of DCF 18 arranged to form a single period of a symmetric dispersion map. An EDFA 20, 22 and a filter 24 follow the first section of DCF 18 and the second section of SMF 16 in each DM transmission line 12. An imperfect splice 40 is provided between the NOLM 14 of a first transmission line element 10 and the DM transmission line 12 of the subsequent transmission line element 10.

As discussed above, the optical pulses are of a first peak optical power level for transmission along a DM transmission line 12. Following transmission along the DM transmission line 12 of a first optical pulse regenerating transmission line element 10, each optical pulse will have been broadened and will have acquired some noise. The optical pulses are then amplified to a second, higher, peak optical power level by the second EDFA 22 before being transmitted through a NOLM 14 which narrows the width of the optical pulse and removes the noise. Following transmission through the NOLM 14, the peak optical power level of the pulses is reduced from the second power level to the first power level by the pulses passing through the lossy splice 40. The regenerated pulses are then, passed into the DM transmission line 12 of the next transmission line element 10, and so on until the optical pulse reaches its destination at the end of the transmission line 60. Each pulse is regenerated a plurality of times, undergoing a series of optical power amplifications and reductions, pulse broadening and narrowing, and noise gain and noise removal, as it is transmitted along the transmission line 60. The peak optical power of the pulses input into the DM transmission line 12 of a second transmission line element 10 is substantially the same as the peak optical power of the pulses when output from the DM transmission line 12 of a first, preceding transmission line element 10.

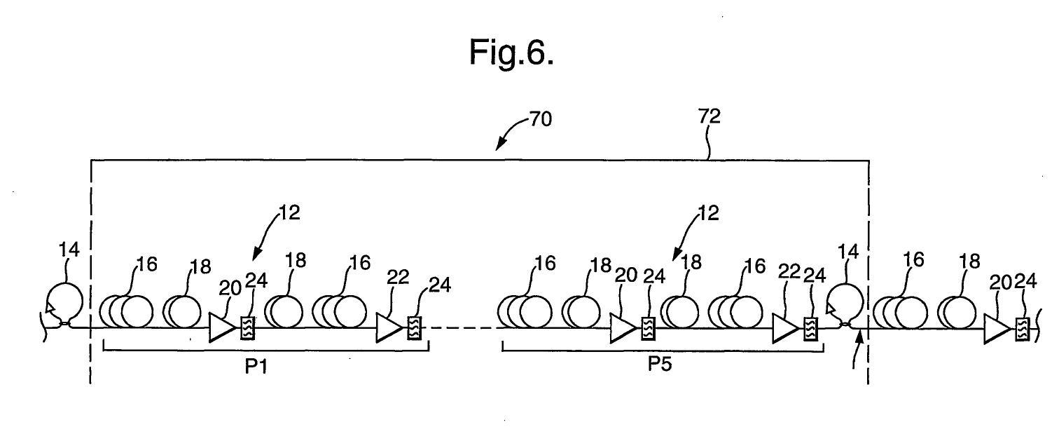

A fourth embodiment of the present invention, shown in FIG. 6, provides an alternative optical pulse regenerating transmission line 70. The same reference numerals are retained for corresponding features.

In this example, the transmission line 70 comprises a plurality of optical pulse regenerating transmission line elements 72 connected together in optical communication, in series. Each transmission line element 72 comprises five periods, P1 to P5, of a symmetric dispersion map DM transmission line 12. Each period P1 to P5 of the DM transmission line 12 comprises, travelling from left to right in FIG. 6, i.e. in the direction of transmission of an optical pulse, a first section of SMF 16, a first section of DCF 18, a first EDFA 20, a first filter 24, a second section of DCF 18, a second section of SMF 16, a second EDFA 22 and a second filter 24. The fifth DM transmission line 12 period, P5, is followed by a NOLM 14 and a loss element 40.

Each pulse is transmitted, at a first peak optical power level, along five dispersion map periods of the DM transmission line 12 as a result of which each pulse will be broadened and will acquire some noise. Within the fifth period P5 of the DM transmission line 12 the pulses are amplified by the second EDFA 22 to a second, higher, peak optical power level, suitable for transmission through the NOLM 14 of the transmission line element 72. The pulses are then transmitted through the NOLM 14, which results in the pulse width decreasing and the noise on the pulses being removed.

Following the NOLM 14, the pulses pass through the lossy splice 40, thereby reducing the pulse peak optical power from the second level to the first level. The regenerated pulses are then transmitted into the next transmission line element 72, and so on until the pulse has reached the destination at the end of the transmission line 70. The effect of each NOLM 14 on the pulses is sufficient to counteract the pulse broadening caused due to transmission along the five periods of the DM transmission line 12. Each NOLM 14 is also able to remove substantially all of the noise added to the pulses during transmission along the DM transmission line 12.

The fourth embodiment of the present invention provides an advantage over the third embodiment of the invention in that the reduced numbers of NOLM 14 used results in a cost saving.

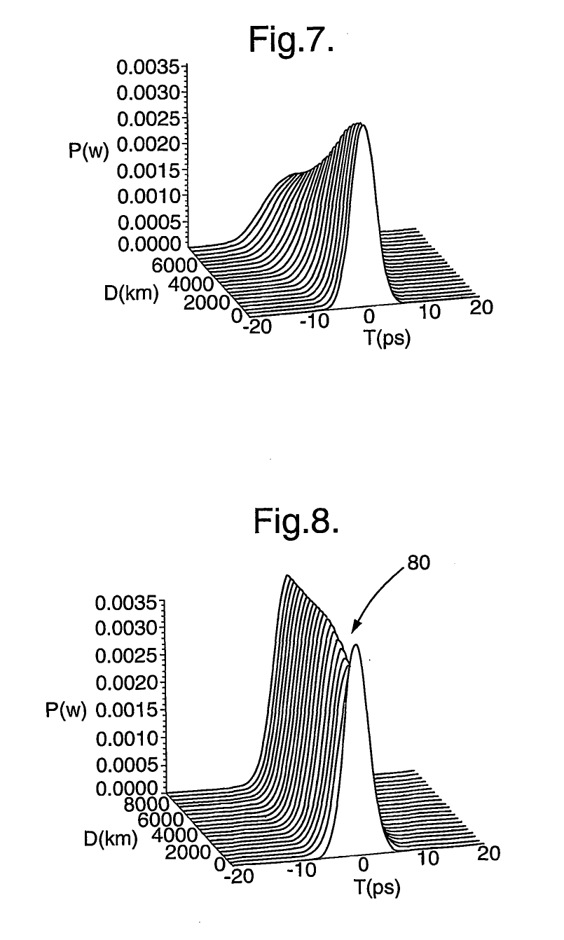

FIGS. 7 and 8 show how the shape of an optical pulse, defined by its duration T(ps) along the X axis, and by its power P(W) along the Y axis, changes with propagation distance D (km) along the Z axis.

An optical pulse transmitted along a standard DM transmission line, shown in FIG. 7, continuously broadens, as discussed above leading to a limit being imposed on the pulse propagation distance. In contrast, the shape of an optical pulse transmitted along an optical pulse regenerating transmission line according to the present invention is shown, in FIG. 8, to have a substantially stable shape over the same transmission distance of approximately 8000 km. Although the pulse suffers an initial transient, indicated generally at 80, the pulse then settles into a substantially stable shape, and retains its shape over a substantially longer propagation distance than in the case of the conventional DM transmission line.

The performance of high-bit rate communication lines is generally tested by examining the maximum propagation distance available for a bit error rate of more than 10⁻⁹. The bit error rate is translated into a standard Q-factor, where a Q of 6 corresponds to a bit error rate of 10⁻⁹, higher values of Q corresponding to lower error rates. The Q-value is the ratio of the separation of adjacent pulses in a pulse train to the variance in the position of an individual pulse within its timing slot.

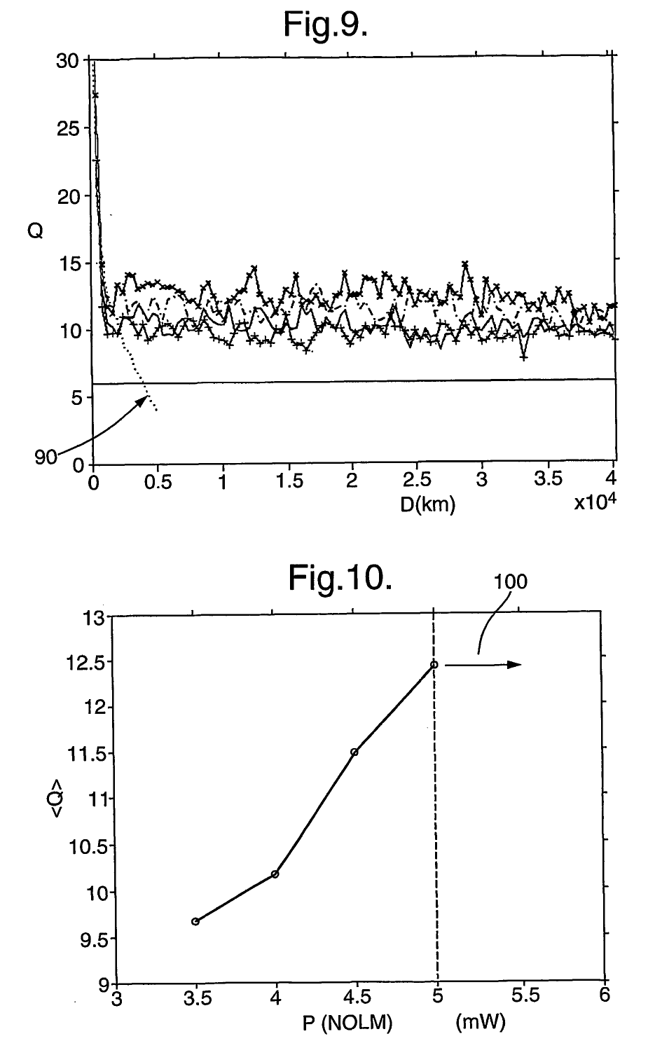

FIG. 9 shows Q-value as function of propagation distance D in 10,000 km units, for a 40 Gbit/s optical pulse data stream. The data stream is modeled by a pseudo-random binary sequence using Gaussian pulses having stationary peak power, width, and chirp. It has been shown that substantially unlimited error-free propagation is possible for pulse peak powers at the NOLM input of between 3.5 and 5.0 mW. Unlimited transmission is taken to mean that after a certain propagation distance, the accumulation of noise and timing jitter through the transmission line is stabilised, yielding a non-decaying Q-value of greater than 6. The Q-value is evaluated just before the NOLM location on the transmission line. The Q-value is shown to stabilise at a Q-value of between 10 and 15. That is to say, the value fluctuates, but does not degrade any further, with propagation distance. The dashed line 90 in FIG. 9 shows the best result achieved for a DM transmission line without NOLMs.

FIG. 10 shows a graph of the mean value around which the stable Q-value fluctuates as a function of the pulse peak power at the NOLM input. The best performance of the transmission line evaluated is achieved for an input peak power of 5.0 mW. It is predicted that for a pulse peak power of greater than 5 mW the mean Q-value varies about a stable value in the region of 12.5.

The above described embodiments of the invention therefore provide an optical pulse regenerating transmission line having an increased pulse propagation distance as compared with a conventional DM transmission line.

The embodiments of the present invention may therefore provide an optical pulse regenerating transmission line element and optical pulse regenerating transmission lines having, essentially, distance unlimited propagation distances, for return-to-zero optical pulse data streams. The disadvantages of dispersion managed return-to-zero optical pulse transmission at high-bit rates is overcome by the use of dispersion management in conjunction with unbalanced optical interferometers, such as a non-linear loop mirror. The suppression of dispersive radiation build up in dispersion managed transmission lines is achieved while retaining the benefits of dispersion managed transmission lines.

The present invention therefore provides an efficient, cost effective fibre optic transmission line advantageous for high-bit rate dispersion managed return-to-zero optical pulse signal transmission. The invention also allows existing standard monomode fibre terrestrial communication links to be upgraded to optical pulse regenerating transmission lines.

Various modifications may be made without departing from the scope of the present invention. For example, the embodiments describe the use of symmetric dispersion maps in the dispersion managed transmission line, but it will be appreciated that other dispersion maps, such as a pre-compensating map or a post-compensating map, may be used instead. Different types of optical fibre may be used, for example the standard monomode fibre may be replaced by any other optical fibre having a positive dispersion coeffient, and the dispersion compensating fibre may be replaced by any type of optical fibre having a negative dispersion coefficient. In addition, the dispersion shifted fibre in the non-linear loop mirror fibre loop may be replaced by a different type of optical fibre.

Although an optical fibre non-linear loop mirror is specifically described, it will be appreciated that the loop mirror may alternatively comprise, in full or in part, a semiconductor waveguide device. An amplifying loop mirror is described, but it will be understood that an alternative type of loop mirror, such as an absorption loop mirror, a dispersion imbalanced loop mirror, or an imbalanced coupler loop mirror, may be used with consequent changes to the optical system.

It will also be appreciated that the non-linear loop mirror, which is a particular form of a Sagnac interferometer, may be replaced by a different unbalanced interferometer, such as a Mach-Zehnder interferometer or a Michelson interferometer. Any such interferometer may be a fibre optic interferometer, or may be, in full or in part, a semiconductor waveguide device.

Although the use of erbium doped fibre amplifiers is particularly described, it will be appreciated that other types of optical amplifier may be used in their place. It will also be appreciated that the Gaussian optical filters described may be replaced by an optical filter of an alternative design, or may have a different transmission profile. The optical amplifiers and the optical filters may be located within the dispersive managed transmission line at different locations than that described.

Referring particularly to the transmission line, it will be appreciated that a different number of periods of the dispersion managed transmission line may be provided between subsequent non-linear optical loop mirrors.

1. An optical pulse regenerating transmission line element comprising a section of dispersion managed optical fibre transmission line in optical communication with an unbalanced optical interferometer.

2. An element as claimed in claim 1, wherein the dispersion managed optical fibre transmission line comprises a first section of optical fibre, having a negative dispersion coefficient, connected to a second section of optical fibre, having a positive dispersion coefficient.

3. An element as claimed in claim 2, wherein the first and second sections of optical fibre are arranged to form a section of dispersion managed optical fibre transmission line having a symmetric dispersion map, or a pre-compensating dispersion map, or a post-compensating dispersion map.

4. An element as claimed in any preceding claim, wherein the unbalanced interferometer is a Sagnac interferometer.

5. An element as claimed in claim 4, wherein the Sagnac interferometer is a fibre optic Sagnac interferometer, such as a non-linear loop mirror.

6. An element as claimed in claim 5, wherein the non-linear loop mirror comprises a 2×2 optical coupler, a first port on one side of the coupler forming the in put to the non-linear optical loop mirror, the second port on the one side forming the output to the non-linear optical loop mirror, and the ports on the other side of the coupler being connected together by a section of optical waveguide, to form a waveguide loop.

7. An element as claimed in claim 6, wherein the optical coupler is a fibre optic coupler or a semiconductor waveguide device, and the optical waveguide comprises a section of optical fibre and/or a section of semiconductor waveguide.

8. An element as claimed in claim 7, wherein the non-linear loop mirror is an amplifying non-linear loop mirror, comprising an optical amplifier asymmetrically located within the fibre loop, or an absorption non-linear loop mirror, comprising an absorption element asymmetrically located within the fibre loop, or a dispersion imbalanced non-linear loop mirror, or an imbalanced coupler non-linear loop mirror.

9. An element as claimed in any of claims 5 to 8, wherein the non-linear loop mirror operates within a region of its switching curve in which the output power of the non-linear loop mirror is substantially stable against small changes in the input power to the non-linear loop mirror.

10. An element as claimed in claim 9, wherein the non-linear loop mirror operates in the region just after the first peak of its switching curve.

11. An element as claimed in any preceding claim, wherein the optical power of a pulse when output from the optical pulse regenerating transmission line element is substantially the same as the optical power of the pulse when input into the optical pulse regenerating transmission line element.

12. An element as claimed in any of claims 5 to 11, wherein the optical pulse transmission line element further comprises an optical power loss element provided at the output of the non-linear loop mirror.

13. An element as claimed in claim 12, wherein the loss element is an absorption element, or an imperfection in the optical waveguide, such as an imperfect splice between two sections of optical fibre.

14. An element as claimed in any of claims 8 to 13, wherein the optical pulse regenerating transmission line element further comprises a second optical amplifier provided between the dispersion managed optical fibre transmission line and the non-linear loop mirror.

15. An element as claimed in claim 14, wherein the length of the loop and the gain of the loop optical amplifier and/or the second optical amplifier are determined in terms of the input power to the non-linear loop mirror.

16. An element as claimed in claim 15, wherein the input power to the non-linear loop mirror is the peak power of an optical pulse to be transmitted through the non-linear loop mirror, the pulse peak power being selected to produce good behaviour of the pulse in-the dispersion managed optical-fibre transmission line.

17. An element as claimed in any of claims 8 to 16, wherein the optical pulse, regenerating transmission line element comprises a third optical amplifier provided at a location along the dispersion managed transmission line, the location being on the section of negative dispersion fibre.

18. An element as claimed in claim 17, wherein the optical pulse regenerating transmission line element further comprises an optical filter after each of the second and third optical amplifiers, each optical filter having a substantially Gaussian shaped transmission profile, the bandwidth of the spectral profile being generally 1.5 times the spectral-bandwidth of the optical pulse.

19. Optical pulse regenerating transmission line components for incorporation into an existing terrestrial communication line which comprises a section of a first optical fibre having a dispersion coefficient of a first sense, the components comprising:
a section of a second optical fibre, having a dispersion coefficient of the opposite sense, connectable in optical communication to a section of the first optical fibre to form therewith a dispersion managed transmission line,
and an unbalanced optical interferometer connectable in optical communication to the dispersion managed transmission line.

20. Components as claimed in claim 19, wherein the first optical fibre has a positive dispersion coefficient, such as standard monomode optical fibre, and the second optical fibre has a negative dispersion coefficient, such as dispersion compensating optical fibre.

21. Components as claimed in claim 20, wherein the negative dispersion fibre and the standard fibre are arranged to form a dispersion managed optical fibre transmission line having a pre-compensating dispersion map, or a post-compensating dispersion map.

22. Components as claimed in claim 20, wherein two sections of negative dispersion fibre are provided, the sections of negative dispersion fibre and the standard monomode fibre are arranged to form a dispersion managed optical fibre transmission line having a symmetric dispersion map.

23. Components as claimed in any of claims 19 to 22, wherein the unbalanced interferometer is a Sagnac interferometer.

24. Components as claimed in claim 23, wherein the Sagnac interferometer is a fibre optic Sagnac interferometer, such as a non-linear loop mirror.

25. Components as claimed in claim 24, wherein the non-linear loop mirror comprises a 2×2 optical coupler, a first port on one side of the coupler forming the input to the non-linear optical loop mirror, the second port on the one side forming the output to the non-linear optical loop mirror, and the ports on the other side of the coupler being connected together by a section of optical waveguide, to form a waveguide loop.

26. Components as claimed in claim 25, wherein the optical coupler is a fibre optic coupler or a semiconductor waveguide device, and the optical waveguide comprises a section of optical fibre and/or a section of semiconductor waveguide.

27. Components as claimed in claim 26, wherein the non-linear loop mirror is an amplifying non-linear loop mirror, comprising an optical amplifier asymmetrically located within the fibre loop, or an absorption non-linear loop mirror, comprising an absorption element asymmetrically located within the fibre loop, or a dispersion imbalanced non-linear loop mirror, or an imbalanced coupler non-linear loop mirror.

28. Components as claimed in any of claims 24 to 27, wherein the non-linear loop mirror operates within a region of its switching curve in which the output power of the non-linear loop mirror is substantially stable against small changes in the input power to the non-linear loop mirror.

29. Components as claimed in claim 28, wherein the non-linear loop mirror operates in the region just after the first peak of its switching curve.

30. Component as claimed in any of claims 24 to 29, wherein the optical pulse regenerating transmission line components further comprise an optical power loss element provided at the output of the non-linear loop mirror.

31. Components as claimed in claim 30, wherein the loss element is an absorption element, or an imperfection in the optical waveguide, such as an imperfect splice between two sections of optical fibre.

32. Components as claimed in any of claims 24 to 31, wherein the optical pulse regenerating transmission line components further comprise a second optical amplifier provided between the dispersion managed optical fibre transmission line-and the non-linear loop mirror.

33. Components as claimed in claim 32, wherein the length of the loop and the gain of the loop optical amplifier and/or the second optical amplifier are determined in terms of the input power to the non-linear loop mirror.

34. Components as claimed in claim 33, wherein the input power to the non-linear loop mirror is the peak power of an optical pulse to be transmitted through the non-linear loop mirror, the pulse peak power being selected to produce good behaviour of the pulse in the dispersion managed optical fibre transmission line.

35. Components as claimed in any of claims 32 to 34, wherein the optical pulse regenerating transmission line components comprise a third optical amplifier provided at a location along the dispersion managed transmission line, the location being on the section of negative dispersion fibre.

36. Components as claimed in claim 35, wherein the optical pulse regenerating transmission line components further comprise an optical filter after each of the second and third optical amplifiers, each optical filter having a substantially Gaussian shaped transmission profile, the bandwidth of the spectral profile being generally 1.5 times the spectral bandwidth of the optical pulse.

37. An optical pulse regenerating transmission line comprising a plurality of optical pulse regenerating transmission line elements as claimed in any of claims 1 to 17 connected in optical communication in series.

38. An optical pulse regenerating transmission line as claimed in claim 37, wherein the optical power of a pulse delivered from a first optical pulse regenerating transmission line element to the dispersion managed transmission line of the subsequent optical pulse regenerating transmission line element is substantially the same as the optical power of the pulse when output from the dispersion managed transmission line of the first optical pulse regenerating transmission line element.

39. An optical pulse regenerating transmission line as claimed in claims 37 or 38, wherein the dispersion managed transmission line comprises a plurality of periods of a dispersion map.

40. An optical pulse regenerating transmission line as claimed in claim 39, wherein a third optical amplifier is provided after each period of the dispersion map.

41. An optical pulse regenerating transmission line as claimed in claims 39 or 40, wherein a third optical amplifier is provided at a location along the dispersion managed optical fibre transmission line, the location being on the section of negative dispersion fibre, substantially at the mid point thereof.

42. An optical pulse regenerating transmission line as claimed in claims 40 or 41, wherein an optical filter is provided after each third optical amplifier.
